(19) United States
(12) Patent Application Publication
(10) Pub. No.: US 2019/0229560 A1
(43) Pub. Date: Jul. 25, 2019

(54) Ultrasonic Power Transmission With Impedance Detection

(71) Applicant: Qualcomm Incorporated, San Diego, CA (US)

(72) Inventors: William Henry Von Novak, III, San Diego, CA (US); Seong Heon Jeong, San Diego, CA (US); Cody Wheeland, San Diego, CA (US)

(21) Appl. No.: 15/875,687

(22) Filed: Jan. 19, 2018

(51) Int. Cl. H02J 50/60; H04B 11/00; H02J 50/15; H02J 7/02

(52) U.S. Cl. CPC H02J 50/60; H02J 7/025; H02J 50/15; H04B 11/00

(57) ABSTRACT

An apparatus is disclosed that implements ultrasonic power transmission with impedance detection. In an example aspect, the apparatus includes an array of ultrasonic transducers and an acoustic-impedance detection system. The acoustic-impedance detection system is configured to transmit an ultrasonic detection pulse from an ultrasonic transducer of the array. Based on the ultrasonic detection pulse, the acoustic-impedance detection system can determine an acoustic impedance at the ultrasonic transducer. Based on the acoustic impedance, the acoustic-impedance detection system can transmit an ultrasonic charging signal.

### TECHNICAL FIELD

This disclosure relates generally to ultrasonic power transmission and, more specifically, to increasing efficiency in ultrasonic power transmission by using impedance detection to improve acoustic coupling.

### BACKGROUND

Mobile electronic devices play an important role in many aspects of modern society. These devices are often our primary computing platform, providing communication, entertainment, social media, email, calendar, and many other services that we use every day. Mobile electronic devices are not merely an accessory, they have become an integral part of our work and personal lives.

Many mobile electronic devices include wireless capabilities. The improvement in access to wireless networks allows nearly constant network connectivity. Of course, a mobile device is typically a battery-powered device. Increased network access, in conjunction with the integration of mobile electronic devices into work and personal activities, has made battery life and the availability of battery charging more important. Historically, keeping a battery charged has meant keeping track of charging cables and adapters, remembering to bring extra batteries (that are charged), and looking for an outlet before the battery dies.

The development of wireless ultrasonic battery charging has helped to address these concerns. In ultrasonic power-transmission systems, ultrasonic power is transmitted via sound waves to a receiver. While convenient, over-the-air systems may have inefficiencies. For one, ultrasonic transducers may have poor acoustic coupling when transmitting over the air. Further, destructive interference between the individual transducers in the system may also be an issue.

### SUMMARY

Apparatuses and methods that enable ultrasonic power transmission with impedance detection are disclosed herein. Example implementations of the disclosed ultrasonic power transmission with impedance detection can operate in a contact mode or an over-the-air (non-contact) mode to facilitate convenient wireless battery recharging with increased efficiency compared to existing systems.

In an example aspect, an apparatus is disclosed. The apparatus includes an array of ultrasonic transducers and an acoustic-impedance detection system. The acoustic-impedance detection system is configured to transmit an ultrasonic detection pulse from an ultrasonic transducer of the array of ultrasonic transducers; determine, based on a response to the ultrasonic detection pulse, an acoustic impedance at the ultrasonic transducer, and transmit, based on the acoustic impedance, an ultrasonic charging signal.

In an example aspect, a wireless power-transmission system is disclosed. The wireless power-transmission system includes a power-transmitting subsystem that includes a power provider and an array of ultrasonic transducers, at least one of the ultrasonic transducers of the array configured to receive, from the power provider, an AC input voltage, convert the AC input voltage to an ultrasonic charging signal, and transmit the ultrasonic charging signal. The wireless power-transmission system also includes an acoustic-impedance detection subsystem configured to detect a change in impedance at the one ultrasonic transducer of the array. Responsive to detecting the change in impedance, the acoustic-impedance detection subsystem is also configured to cause the power-transmitting subsystem to continue to receive the AC input voltage at the one ultrasonic transducer and, responsive to not detecting the change in impedance, cause the power-transmitting subsystem to discontinue receiving the AC input voltage at the one ultrasonic transducer. The wireless power-transmission system also includes a power-receiving subsystem that includes another array of ultrasonic transducers, at least one of the ultrasonic transducers of the other array configured to receive the ultrasonic charging signal, convert the ultrasonic charging signal to an AC output voltage, and transmit the AC output voltage to a charging subsystem. The charging subsystem is configured to receive the AC output voltage, convert the AC output voltage to a DC voltage, and transmit the DC voltage.

In an example aspect, a method for detecting an electronic device with acoustic impedance is disclosed. The method includes transmitting an ultrasonic detection pulse from at least one ultrasonic transducer of an array of ultrasonic transducers, and determining, based on a response to the ultrasonic detection pulse, an acoustic impedance at the one ultrasonic transducer. The method also includes transmitting, based on the acoustic impedance, an ultrasonic charging signal from the one ultrasonic transducer or from another one of the ultrasonic transducers of the array.

In an example aspect, an apparatus is disclosed. The apparatus includes an array of ultrasonic transducers configured to receive an ultrasonic confirmation pulse from an ultrasonic charging device, receive an ultrasonic charging signal from the ultrasonic charging device, convert the ultrasonic charging signal to an AC output voltage, and transmit the AC output voltage. The apparatus also includes an acoustic-impedance feedback system, communicatively coupled with the array of ultrasonic transducers and configured to determine that the ultrasonic confirmation pulse at a particular ultrasonic transducer of the array has a power level or a duration that exceeds a threshold value. Responsive to determining that the power level or the duration of the ultrasonic confirmation pulse at the particular ultrasonic transducer exceeds the threshold value, the acoustic-impedance feedback system is also configured to cause the particular ultrasonic transducer to initiate a modulation of an acoustic impedance of the particular ultrasonic transducer, the modulation detectable by the ultrasonic charging device. The apparatus also includes a charging system that is communicatively coupled with the array of ultrasonic transducers and configured to charge a load of the apparatus, based on the AC output voltage.

### BRIEF DESCRIPTION OF DRAWINGS

FIG. 1 illustrates an example environment in which ultrasonic power transmission with impedance detection can be implemented.

FIG. 2 illustrates an example implementation of an ultrasonic power-transmission device that can be implemented with ultrasonic power transmission with impedance detection.

FIG. 3 illustrates an example implementation of an electronic device that can be implemented with ultrasonic power transmission with impedance detection.

FIG. 4, FIG. 5, and FIG. 6 illustrate additional details of the electronic device of FIG. 3.

FIG. 7 illustrates an example of a wireless power-transmission system for implementing ultrasonic power transmission with impedance detection.

FIG. 8 illustrates an example of circuitry for implementing ultrasonic power transmission with impedance detection.

FIG. 9 and FIG. 10 illustrate additional details of the example circuitry of FIG. 8.

FIG. 11-A and FIG. 11-B are a flow diagrams illustrating an example process for implementing ultrasonic power transmission with impedance detection.

FIG. 12 illustrates an example wireless power-transmission system that can be used to implement ultrasonic power transmission with impedance detection.

### DETAILED DESCRIPTION

Improvements in battery technology, along with the advent of sophisticated and efficient power management tools have increased battery life for many mobile electronic devices. As network access has become nearly universal, and applications for mobile electronic devices have become more data- and video-centric, battery life and access to battery charging services have become more important.

The development of wireless battery charging has helped to address this problem. Ultrasonic power may be transmitted through the air to a receiver. Individual ultrasonic transducer elements that transmit and receive the ultrasonic signals may suffer from poor acoustic coupling over the air at standard operating power levels. Destructive interference between the individual transducers in the system is also a challenge.

Implementations of ultrasonic power transmission with impedance detection that are described herein enable an ultrasonic wireless power-transmission system that can operate in either an over-the-air (non-contact) mode or in a contact mode. In the over-the-air mode, the system can take advantage of lower power levels, using resonance and other techniques to improve efficiency. In the contact mode, the system can use higher power levels, along with resonance and efficient coupling materials to improve performance. The over-the-air mode uses tuned resonance cavities and an array of ultrasonic transducers to harvest energy from a transmitted ultrasonic signal. The contact mode uses the resonance cavities and a removable acoustic coupling body (usually integrated into a smartphone case or similar covering) to allow a direct propagation path between an array of ultrasonic transducers on a charging device, such as a charging pad, and an array of ultrasonic transducers on a device that is to be charged. The arrangement of the arrays and the size of the individual ultrasonic transducers helps reduce destructive interference between the ultrasonic transducers.

Additionally, in the contact mode, (e.g., on a charging device such as a charging pad), the described systems can use a relatively large array of ultrasonic transducers that can search for a device placed on the pad. When a device is found, only on those transducers that are actually in a position to provide power to the device are powered, which can increase the efficiency of the charging device. The system detects devices on the charging device by detecting changes in impedance seen by the ultrasonic transducers on the charging device and by using a feedback system that can detect modulation of the impedance by the device to be charged. The described techniques thus enable wireless charging in two modes (over-the-air and contact) and enable efficient charging of mobile electronic devices, even in environments in which electromagnetic (EM) interference cannot be tolerated.

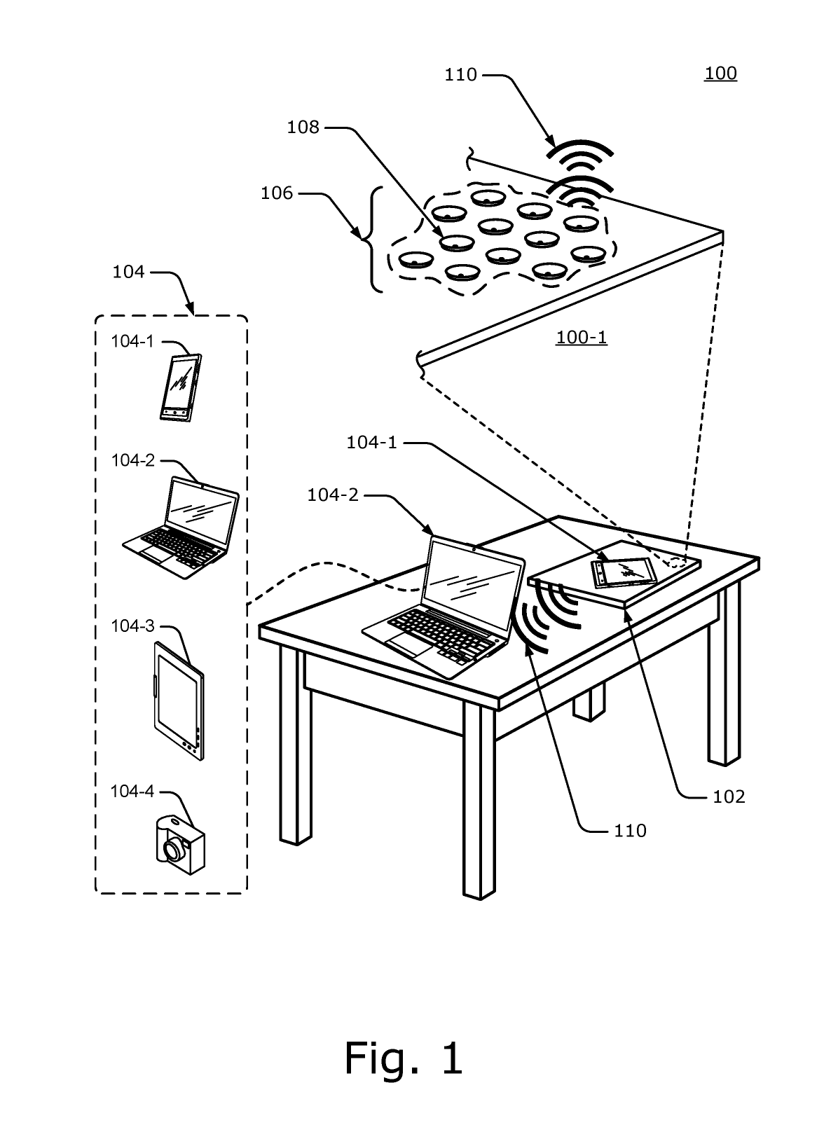

FIG. 1 illustrates an example environment 100 in which ultrasonic power transmission with impedance detection can be implemented. The example environment 100 includes an ultrasonic power-transmission device 102 and an electronic device 104 that can be charged via the ultrasonic power-transmission device 102. The electronic device 104 is illustrated with various non-limiting example devices: smartphone 104-1, laptop 104-2, tablet 104-3, and camera 104-4. The ultrasonic power-transmission device 102 is shown as a desktop charging pad, but may take a variety of other forms (e.g., a contoured or shaped charging receptacle, a pedestal charging stand, or a flexible charging mat).

The ultrasonic power-transmission device 102 includes an ultrasonic transmitter-transducer array 106 (transmitter array 106). The transmitter array 106 includes at least one ultrasonic transmitting-transducer 108 (transmitter 108). The transmitter 108 may be a variety of types of ultrasonic transducer, such as a piezoelectric transducer or a capacitive transducer. While designated as a transmitter for clarity, it should be noted that the transmitter 108 may be a transducer, which can operate to both transmit and receive ultrasonic signals.

To improve overall efficiency of the array 106, the transmitters 108 can be powered independently (e.g., while there is power to the array 106, individual transmitters 108 may be turned on and off independently). In some implementations, the array 106 may be further grouped into one or more subarrays (e.g., including two or more of the transmitters 108), that can also be powered individually. A cutaway detail view 100-1 shows each transmitter 108 of the transmitter array 106 as a circular element and arranged in a grid. In other implementations, the transmitter array 106 may take different shapes (e.g., rectangular, hexagonal, or pentagonal). Additional details of the array 106 and the transmitter 108 are described with reference to FIG. 5 and FIG. 6.

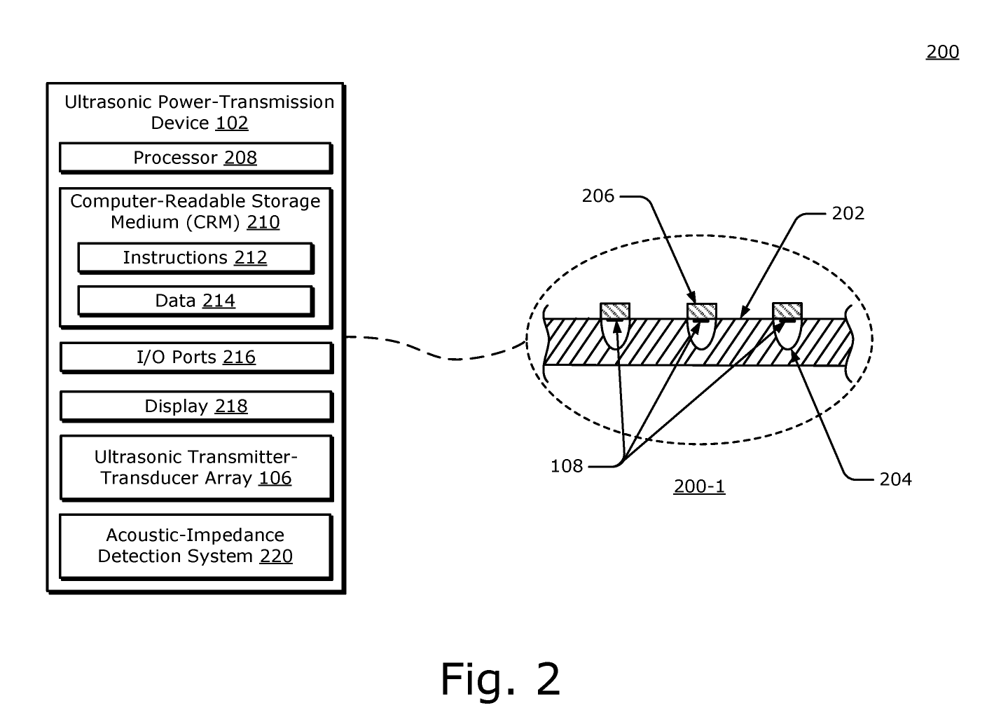

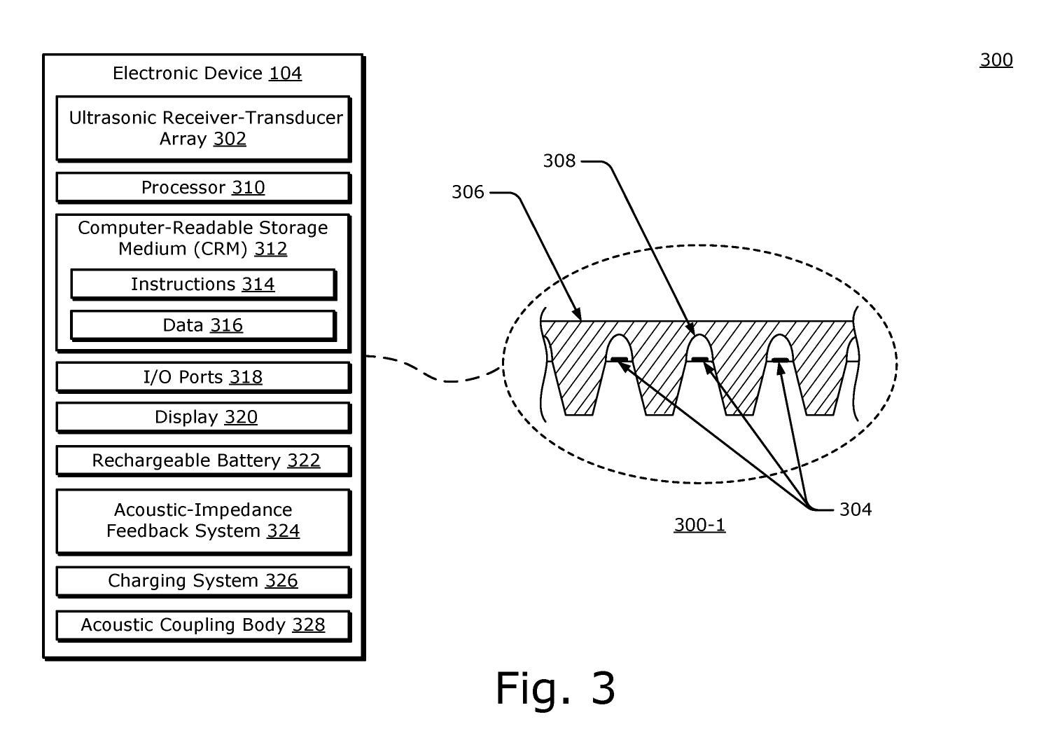

The ultrasonic power-transmission device 102 can provide wireless power to the electronic device 104 via an ultrasonic charging signal 110 in a contact mode or an over-the-air (non-contact) mode. For example, in the contact mode, the ultrasonic charging signal 110 can be can be transmitted from the ultrasonic power-transmission device 102 to a smartphone (e.g., the electronic device 104-1) that is placed on the ultrasonic power-transmission device 102. The ultrasonic charging signal 110 is transmitted from the transmitters 108 of the transmitter array 106 to the electronic device 104-1, as shown in the detail view 100-1. In the over-the-air mode, the ultrasonic charging signal 110 can be transmitted to the electronic device 104 without physical contact. For example, as shown in FIG. 1, the ultrasonic charging signal 110 can propagate through the air to charge a laptop (e.g., the electronic device 104-2) that is near the ultrasonic power-transmission device 102. The ultrasonic power-transmission device 102, the electronic device 104, the transmitter array 106, and the transmitter 108 are described in additional detail in this specification (e.g., at least in FIG. 2 and FIG. 3).

FIG. 2 illustrates an example implementation 200 of the ultrasonic power-transmission device 102 that can be implemented with ultrasonic power transmission with impedance detection. The example ultrasonic power-transmission device 102 includes an array of ultrasonic transducers, such as the transmitter array 106 described with reference to FIG. 1. A detail view 200-1 shows a cross-section of the example ultrasonic power-transmission device 102 that includes a housing 202 that supports the transmitter array 106. The housing 202 includes transmission resonance cavities 204 disposed in a surface of the housing. The transmission resonance cavities 204 are adjacent to corresponding transmitters 108 and arranged such that the power transmitted by the ultrasonic charging signal 110 is increased via resonance in the transmission resonance cavities 204. The transmission resonance cavities 204 may be a variety of shapes (e.g., spherical, elliptical, or conical), depending on the geometry of the transmitter 108 and the frequency of the transmitted signal.

The ultrasonic power-transmission device 102 may also include a transmitter coupling material 206 that is disposed adjacent to the transmitters 108, such that a signal transmitted from the transmitters 108 (e.g., the ultrasonic charging signal 110) propagates through the transmitter coupling material 206. The transmitter coupling material 206 may be made from a variety of materials that are efficient conductors of ultrasonic signals, such as metals (e.g., alloys of aluminum, copper, or titanium), polystyrenes, butyl rubbers, polyethylene, melamine, or polyamides such as nylon 66 (also known as nylon 6-6, nylon 6/6 or nylon 6,6). As shown in FIG. 2, the transmitter coupling material 206 is rectangular structure that is adjacent to a single transmitter 108. In other implementations, the transmitter coupling material 206 may be other shapes (e.g., a dome, a truncated cone, a cube, or a cylinder). Further, the transmitter coupling material 206 may be a set of multiple individual items that are particular to a corresponding transmitter 108 (or to a corresponding subarray) or a single contiguous piece that covers all or part of the transmitter array 106. In some implementations, the ultrasonic charging signal 110 propagates from the transmitter array 106 through the transmitter coupling material 206 and through a removable coupling material that is disposed between the array 106 and the electronic device and is in contact with the transmitter coupling material 206 and with the electronic device, so as to provide a contiguous path for propagation of the ultrasonic charging signal 110.

In some implementations, the removable coupling material and the transmitter coupling material 206 may be made from a similar or same material. In other cases, the removable coupling material may be made from a variety of materials with an ultrasonic velocity (a speed at which longitudinal ultrasonic waves propagate through the material) that exceeds a threshold value. For example, the threshold may be a minimum velocity in meters per second (m/s), such as 1000 m/s, 1200 m/s, 1600 m/s, or 2400 m/s. In implementations in which the removable coupling material is removed, the transmitter array 106 can transmit the ultrasonic charging signal 110 across a gap (e.g., an air gap) between the transmitter array 106 and the electronic device.

As shown in FIG. 2, the ultrasonic power-transmission device 102 may also include a processor 208 and/or a computer-readable storage medium 210 (CRM 210). The processor 208 may be any type of processor, such as an application processor or multi-core processor, that is configured to execute processor-executable instructions (e.g., code) stored by the CRM 210. The CRM 210 may include any suitable type of data storage media, such as volatile memory (e.g., random access memory (RAM)), non-volatile memory (e.g., Flash memory), optical media, magnetic media (e.g., disk or tape), and so forth. The CRM 210 may be implemented to store instructions 212, data 214, and other information of the ultrasonic power-transmission device 102, and thus does not include transitory propagating signals or carrier waves.

Further, the ultrasonic power-transmission device 102 may include input/output ports 216 (I/O ports 216) and/or a display 218. The I/O ports 216 enable data exchanges or interaction with other devices, networks, or users. The I/O ports 216 may include serial ports (e.g., universal serial bus (USB) ports), parallel ports, audio ports, infrared (IR) ports, and so forth. The display 218 presents graphics of the ultrasonic power-transmission device 102, such as a user interface associated with an operating system, program, or application. Alternatively or additionally, the display 218 may be implemented as a display port or virtual interface through which graphical content of the ultrasonic power-transmission device 102 is communicated or presented. In some implementations, the ultrasonic power-transmission device 102 may include a user interface that can be used to control the ultrasonic power-transmission device 102 (e.g., touch-pad, a keyboard, or other controls).

The ultrasonic power-transmission device 102 also includes an acoustic-impedance detection system 220 that can transmit an ultrasonic detection pulse from the transmitters 108 of the transmitter array 106. The ultrasonic detection pulse is an ultrasonic signal that has a duration that is less than a predefined duration (e.g., less than approximately 100 milliseconds or less than approximately 200 milliseconds). Based on the ultrasonic detection pulse (e.g., based on a response to the ultrasonic detection pulse, such as detecting a reflection of, or a resistance to, the ultrasonic detection pulse), the acoustic-impedance detection system 220 can determine an acoustic impedance at the transmitter 108. Based on the determined acoustic impedance, the acoustic-impedance detection system 220 can transmit an ultrasonic charging signal (e.g., the ultrasonic charging signal 110) from the transmitter 108 (or from the array 106) to the electronic device (e.g., the electronic device 104).

The acoustic-impedance detection system 220 may be implemented such that the acoustic impedance is determined independently at the individual transmitters 108 by transmitting the ultrasonic detection pulse from each transmitter 108 one at a time. In this implementation, the acoustic-impedance detection system 220 may transmit the ultrasonic detection pulse in a sequence of adjacent transmitters 108 (e.g., beginning at an edge, a corner, or a center of the ultrasonic power-transmission device 102), in another pattern. For example the acoustic-impedance detection system 220 may transmit the ultrasonic detection pulses from randomly selected transmitters 108 until a response is detected and then continue to transmit pulses in a pattern (e.g., a spiral or concentric pattern centered at the transmitter 108 at which the response to the ultrasonic detection pulse was detected). In still other implementations, the acoustic-impedance detection system 220 may determine the acoustic impedance by transmitting the ultrasonic detection pulse from the entire transmitter array 106 all at once (or from one or more subarrays, as described above). Additionally, the ultrasonic power-transmission device 102 may transmit the detection pulse periodically. For example, the ultrasonic detection pulse may be transmitted when power is applied to the ultrasonic power-transmission device 102 (e.g., at start up or after a power outage) or at approximately regular intervals (e.g., every five seconds, every 30 seconds, or every two minutes).

As noted, in some implementations the acoustic-impedance detection system 220 can transmit an ultrasonic charging signal (e.g., the ultrasonic charging signal 110) to the electronic device, based on the acoustic impedance. Additionally or alternatively, the acoustic-impedance detection system 220 can determine that a difference between the determined acoustic impedance at the transmitter 108 and the control value of acoustic impedance indicates a presence of an object. Based on the difference, the acoustic-impedance detection system 220 may determine that the object is in contact with, or within a threshold distance from, the ultrasonic power-transmission device 102 (e.g., within one millimeter (mm) or 100 mm). For example, in implementations in which the control value of acoustic impedance is that of air, the acoustic-impedance detection system 220 can compare the determined value of acoustic impedance at one or more of the transmitters 108 with the control value. When the determined value is different from the control value, the difference may indicate that something other than air (e.g., the electronic device 104) is in contact with, or near to, the array 106 or the particular transmitter 108 that is performing the determination.

In response to determining that the difference in acoustic impedance indicates the presence of the object, the acoustic-impedance detection system 220 can transmit an ultrasonic confirmation pulse. The ultrasonic confirmation pulse may be transmitted from the transmitter 108 that transmitted the ultrasonic detection pulse or from a different transmitter 108. The ultrasonic confirmation pulse may be an ultrasonic signal that has a longer duration than the ultrasonic detection pulse and/or a higher power level. The ultrasonic power-transmission device 102 may then receive, in response to the ultrasonic confirmation signal, a response signal from the detected object (e.g., the electronic device 104). In some implementations, the acoustic-impedance detection system 220 can detect a modulation of the determined acoustic impedance. In this case, the response signal may be a modulation of the acoustic impedance. Additional details of the modulation are described with reference to FIG. 3.

Based on the response signal, the acoustic-impedance detection system 220 can transmit an ultrasonic charging signal (e.g., the ultrasonic charging signal 110) from the transmitter 108 (or from the array 106) to the electronic device. As with the ultrasonic detection pulse, the ultrasonic confirmation pulse may be transmitted from individual transmitters 108 one at a time or from the array 106 (or from one or more subarrays) all at once. Further, the ultrasonic charging signal may be transmitted from the transmitter 108 that transmitted the ultrasonic detection pulse or from a different transmitter 108.

FIG. 3 illustrates an example implementation 300 of an electronic device 104 that can be implemented with ultrasonic power transmission with impedance detection. The example electronic device 104 also includes an array of ultrasonic transducers (ultrasonic receiver-transducer array 302 or receiver array 302). The receiver array 302 includes at least one ultrasonic receiving-transducer 304 (receiver 304). The receiver 304 may be a variety of types of ultrasonic transducer, such as a piezoelectric transducer or a capacitive transducer. While designated as a receiver for clarity, it should be noted that the receiver 304 may be a transducer, which can operate to both transmit and receive ultrasonic signals.

To improve the overall efficiency of the receiver array 302, the receivers 304 can be powered independently (e.g., individual receivers 304 may receive the ultrasonic charging signal 110 independently from each other). In some implementations, the receiver array 302 may be further grouped into one or more subarrays (e.g., including two or more of the receivers 304), that can also be powered individually. Additional details of the receiver array 302 and the receiver 304 are described with reference to FIG. 5 and FIG. 6.

The receiver array 302 can receive an ultrasonic confirmation pulse from an ultrasonic charging device (e.g., the ultrasonic confirmation pulse from the ultrasonic power-transmission device 102). The receiver array 302 can also receive an ultrasonic charging signal (e.g., the ultrasonic charging signal 110) from an ultrasonic charging device, such as the ultrasonic power-transmission device 102. The receiver array 302 can convert the ultrasonic charging signal 110 to an AC output voltage and transmit the AC output voltage.

A detail view 300-1 shows a cross-section of the example electronic device 104 that includes a device case 306 that supports the receiver array 302. The device case 306 includes reception resonance cavities 308 disposed in a surface of the device case. The reception resonance cavities 308 are adjacent to corresponding receivers 304 and arranged such that the power received through the ultrasonic charging signal 110 is increased via resonance in the reception resonance cavities 308. The reception resonance cavities 308 may be a variety of shapes (e.g., spherical, elliptical, or conical), depending on the geometry of the receiver 304 and the frequency of the transmitted signal. As shown in FIG. 3, the device case 306 is manufactured such that the receivers 304 are disposed within the reception resonance cavities 308, leaving a partial volume of the reception resonance cavity 308 on two sides of the receiver 304. In other implementations, the receiver 304 may be in a different position (e.g., closer to, or farther from, an opening of the reception resonance cavity 308).

As shown in FIG. 3, the electronic device 104 may also include a processor 310 and/or a computer-readable storage medium 312 (CRM 312). The processor 310 may be any type of processor, such as an application processor or multi-core processor, that is configured to execute processor-executable instructions (e.g., code) stored by the CRM 312. The CRM 312 may include any suitable type of data storage media, such as volatile memory (e.g., random access memory (RAM)), non-volatile memory (e.g., Flash memory), optical media, magnetic media (e.g., disk or tape), and so forth. The CRM 312 may be implemented to store instructions 314, data 316, and other information of the electronic device 104, and thus does not include transitory propagating signals or carrier waves.

Further, the electronic device 104 may include input/output ports 318 (I/O ports 318) and/or a display 320. The I/O ports 318 enable data exchanges or interaction with other devices, networks, or users. The I/O ports 318 may include serial ports (e.g., universal serial bus (USB) ports), parallel ports, audio ports, infrared (IR) ports, and so forth. The display 320 presents graphics of the electronic device 104, such as a user interface associated with an operating system, program, or application. Alternatively or additionally, the display 320 may be implemented as a display port or virtual interface through which graphical content of the electronic device 104 is communicated or presented. The electronic device 104 may also include a rechargeable battery 322 that can be used to power the electronic device 104 (e.g., a nickel-cadmium battery, a lithium-ion battery, or a nickel-metal-hydride battery). In some implementations, the electronic device 104 may include a user interface that can be used to control the electronic device 104 (e.g., touch-pad, a keyboard, or other controls).

The electronic device 104 also includes an acoustic-impedance feedback system 324 that is communicatively coupled with the receiver array 302. The acoustic-impedance feedback system 324 can determine that the ultrasonic confirmation pulse, at a particular receiver 304 of the receiver array 302, has a power level or a duration that exceed respective threshold values (in some cases, both the power level and the duration may exceed their respective thresholds). In response to determining that either or both of the power level or the duration of the ultrasonic confirmation pulse at the particular ultrasonic transducer of the array exceeds the respective threshold value, the acoustic-impedance feedback system 324 can cause the particular receiver 304 to initiate a modulation of an acoustic impedance of the particular ultrasonic transducer. The modulation may be a modulation at a particular frequency (e.g., a one kilohertz modulation or a three kilohertz modulation) and is detectable by the ultrasonic charging device.

Additionally, the electronic device 104 includes a charging system 326 that is communicatively coupled with the receiver array 302. The charging system 326 can receive the AC output voltage transmitted by the receiver array 302 and convert the AC output voltage to a DC voltage. The charging system 326 can transmit the DC voltage (e.g., to a battery, such as the rechargeable battery 322).

In some implementations, the electronic device 104 also includes a removable acoustic coupling body 328 that can be disposed between the receiver array 302 and an ultrasonic charging device, such as the ultrasonic power-transmission device 102, so as to provide a contiguous path for propagation of the ultrasonic confirmation pulse and the ultrasonic charging signal 110. In implementations in which the acoustic coupling body 328 is removed, the receiver array 302 can receive the ultrasonic confirmation pulse and the ultrasonic charging signal 110 across a gap (e.g., an air gap) between the receiver array 302 and the ultrasonic charging device. In implementations in which the acoustic coupling body 328 is not removed, the receiver array 302 can receive the ultrasonic confirmation pulse and the ultrasonic charging signal 110 via propagation through the acoustic coupling body 328. The acoustic coupling body 328 can be made from a variety of materials that are efficient conductors of ultrasonic signals, such as metals (e.g., alloys of aluminum, copper, or titanium), polystyrenes, butyl rubbers, polyethylene, melamine, or polyamides such as nylon 66 (also known as nylon 6-6, nylon 6/6 or nylon 6,6). The acoustic coupling body 328 may be made from a material that has an ultrasonic velocity that exceeds a threshold value. As noted with respect to the transmitter coupling material 206 and the acoustic coupling material described in FIG. 2, the threshold may be a minimum velocity in meters per second (m/s), such as 1000 m/s, 1200 m/s, 1600 m/s, or 2400 m/s.

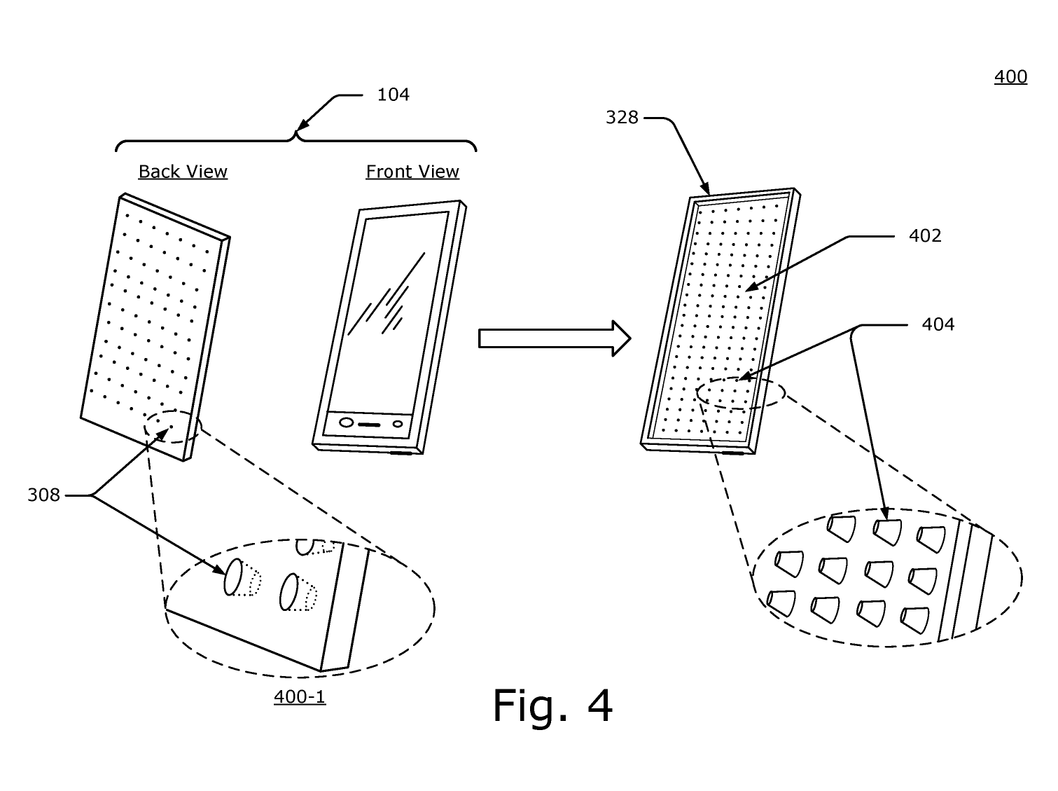

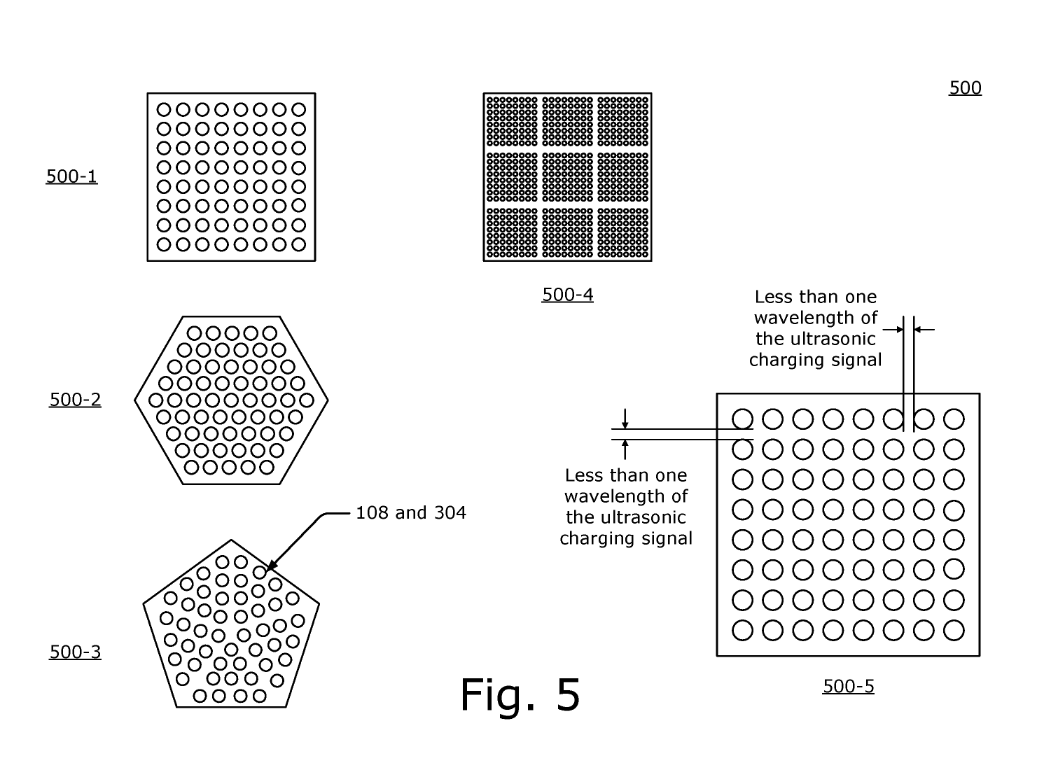

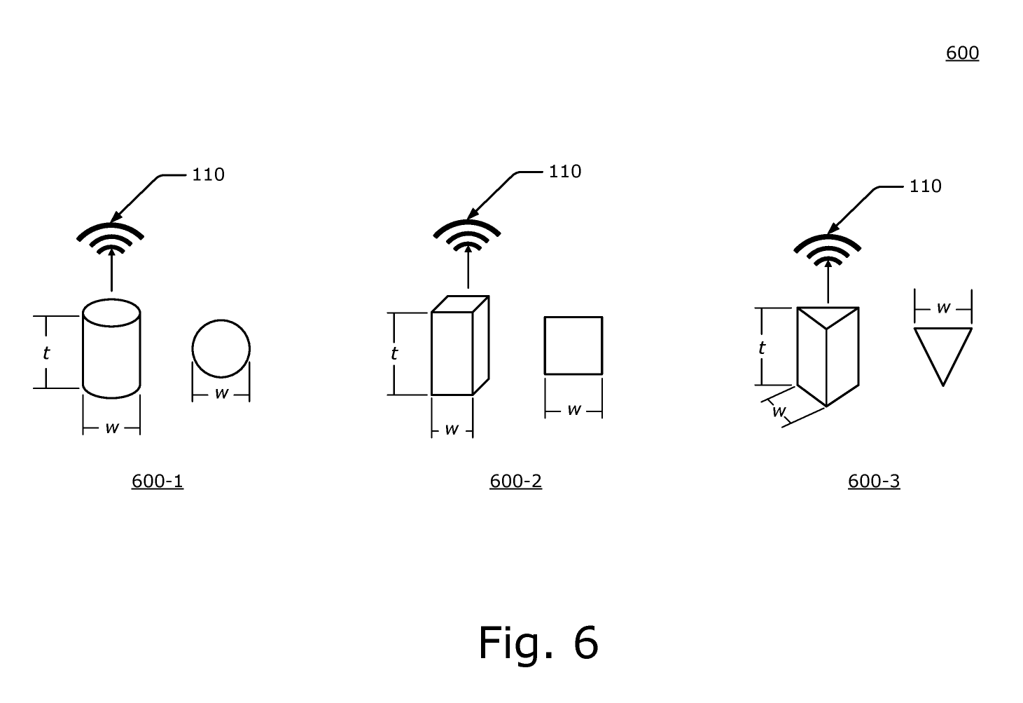

FIG. 4 illustrates an example implementation 400 of the acoustic coupling body 328 of FIG. 3. In the example implementation 400, the acoustic coupling body 328 is a smartphone cover, but it may take other forms. The electronic device 104 is shown in a back view and a front view. The reception resonance cavities 308 are shown in the back view and enlarged in a detail view 400-1. FIG. 4 also shows the acoustic coupling body 328, including a detail view 400-2 that shows details of a mating surface 402 of the acoustic coupling body 328. In the example implementation 400, the mating surface 402 includes mating nodes 404 that are shaped as truncated cones to mate with the reception resonance cavities 308 and provide a contiguous path for propagation of the ultrasonic charging signal 110. Other configurations of the mating nodes 404 may also be used (e.g., semi-spherical, pyramidal) and the mating nodes 404 may be arranged in a variety of patterns other than a grid as shown in FIG. 4 (e.g., triangular or hexagonal groupings). In implementations in which the removable coupling body is removed, the receiver array 302 can receive the ultrasonic charging signal 110 across a gap (e.g., an air gap) between the receiver array 302 and the ultrasonic power-transmission device 102.

FIG. 5 illustrates generally, at 500, example implementations of the transmitter array 106 of FIG. 2 and the receiver array 302 of FIG. 3. Detail views 500-1, 500-2, and 500-3 show example implementations that can be used for either or both of the transmitter array 106 and the receiver array 302. The detail views 500-1, 500-2, and 500-3 show multiple ultrasonic transducers (e.g., the transmitter 108 and/or the receiver 304) arranged in a rectangular array, a hexagonal array, and a pentagonal array, respectively. Another detail view 500-4 shows an example implementation of an array of ultrasonic transducers that is made up of multiple subarrays. In the detail view 500-4, the array and the multiple subarrays are rectangular (as in the detail view 500-1), but other arrangements of subarrays may also be used. In some implementations, a distance between the ultrasonic transducers is more than a length of one wavelength (λ) of the ultrasonic charging signal 110. In other implementations, as shown in a detail view 500-5, the distance between the ultrasonic transducers is less than a length of one wavelength (λ) of the ultrasonic charging signal 110. In this way, interference and/or cancellation effects between the ultrasonic charging signals 110 emitted by the individual ultrasonic transducers can be reduced.

FIG. 6 illustrates generally, at 600, example implementations of the transmitter 108 of FIG. 2 and the receiver 304 of FIG. 3. Detail views 600-1, 600-2, and 600-3 show example implementations (in three-dimensional and cross-sectional views) that can be used for either or both of the transmitter 108 and the receiver 304. The detail views 600-1, 600-2, and 600-3 show ultrasonic transducers (e.g., the transmitter 108 and/or the receiver 304) in cylindrical, rectangular, and triangular configurations, respectively. As shown in FIG. 6, the ultrasonic transducers have a thickness dimension (t) that is measured approximately parallel to a direction in which the ultrasonic charging signal 110 propagates and a width dimension (w) that is measured in a direction approximately perpendicular to the thickness.

In some implementations, to improve resonance and thereby increase the power transmitted and/or received by the ultrasonic transducer, the ultrasonic transducer is configured so that the thickness is greater than the width and the width is approximately λ. Additionally or alternatively, the thickness of the ultrasonic transducer may be related to λ so as to cause the ultrasonic transducers to operate as resonant transducers. For example, the thickness may be proportional to λ or be related to λ by an equation (e.g., t=n×λ/4 or t=n×λ/2, where n is a whole number).

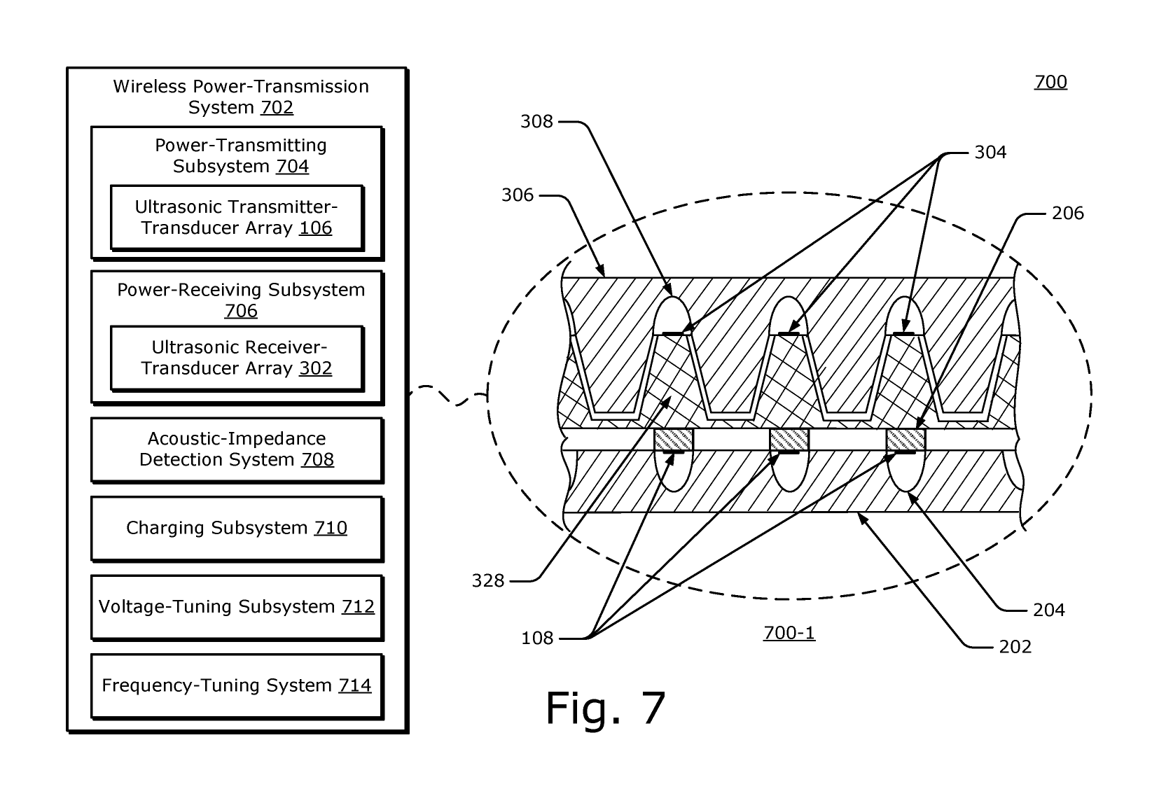

FIG. 7 illustrates an example implementation 700 of a wireless power-transmission system 702 for implementing ultrasonic power transmission with impedance detection. The example wireless power-transmission system 702 includes a power-transmitting subsystem 704 (e.g., the ultrasonic power-transmission device 102), a power-receiving subsystem 706 (e.g., the electronic device 104), an acoustic-impedance detection subsystem 708 (e.g., the acoustic-impedance detection system 220), and a charging subsystem 710 (e.g., the charging system 326). FIG. 7 also includes a detail view 700-1 shows a cross-section of the example wireless power-transmission system 702. The detail view 700-1 shows items already described with reference to other figures, including the transmitters 108 of FIG. 1, the housing 202, transmission resonance cavities 204, and transmitter coupling material 206 of FIG. 2, and the receivers 304, device case 306, reception resonance cavities 308, and acoustic coupling body 328 of FIG. 3.

The power-transmitting subsystem 704 includes a power provider (e.g., an input power amplifier), an array of ultrasonic transducers, such as the transmitter array 106. The transmitter array 106 includes at least one ultrasonic transducer (e.g., the transmitter 108). As described with reference to FIG. 1 and FIG. 2, the transmitter 108 can receive an AC input voltage from the power provider, convert the AC input voltage to an ultrasonic charging signal (e.g., the ultrasonic charging signal 110), and transmit the ultrasonic charging signal 110.

The acoustic-impedance detection subsystem 708 can detect acoustic impedance at the transmitter 108. For example, as noted with reference to FIG. 2, the acoustic-impedance detection system 220 can detect a change in acoustic impedance at a particular transmitter 108 and, in response to detecting the change in impedance, cause the power-transmitting subsystem 704 to continue to receive the AC input voltage at the particular transmitter 108. For particular transmitters 108 at which the acoustic-impedance detection system 220 does not detect a change in impedance, the acoustic-impedance detection system 220 can cause the power-transmitting subsystem 704 to discontinue receiving the AC input voltage the particular transmitter 108. For example, the power-transmitting subsystem 704 may provide the AC input voltage to each transmitter 108 independently and also perform the acoustic impedance detection the transmitters 108 one at a time. In such a case, the power-transmitting subsystem 704 can continue to provide the AC input voltage to the particular transmitters 108 for which a change in acoustic impedance is detected and discontinue the AC input voltage to the particular transmitters 108 for which no change is detected.

The power-receiving subsystem 706 includes another array of ultrasonic transducers, such as the receiver array 302. The receiver array 302 includes at least one ultrasonic transducer (e.g., the receiver 304). As described with reference to FIG. 3, the receiver 304 can receive the ultrasonic charging signal 110, convert the ultrasonic charging signal 110 to an AC output voltage, and transmit the AC output voltage to a charging subsystem such as the charging system 326. The charging system 326 can receive the AC output voltage from respective receivers 304, convert the AC output voltage to a DC voltage, and transmit the DC voltage (e.g., to a battery such as the rechargeable battery 322 of the electronic device 104).

In some implementations, the acoustic-impedance detection subsystem 708 may be used to detected whether an object is proximate to the power-transmitting subsystem 704. For example, the acoustic-impedance detection system 220 can detect a change in acoustic impedance at a particular transmitter 108, as described with reference to FIG. 2, by transmitting an ultrasonic detection pulse from the transmitter 108. Based on a response to the ultrasonic detection pulse, the acoustic-impedance detection system 220 can determine an acoustic impedance at the transmitter 108 and compare the determined acoustic impedance to a control value of acoustic impedance (e.g., the acoustic impedance of air).

The acoustic-impedance detection system 220 may also determine that a difference between the determined acoustic impedance and the control value of acoustic impedance indicates the presence of an object (e.g., the electronic device 104). In response to determining that the difference indicates the presence of the object, the acoustic-impedance detection system 220 can transmit an ultrasonic confirmation pulse that has a power level and a duration sufficient to cause the power-receiving subsystem to modulate the acoustic impedance. The acoustic-impedance detection system 220 can detect the modulation.

As noted, the wireless power-transmission system 702 may operate in a contact mode or an over-the-air (non-contact) mode. In the contact mode, a removable acoustic coupling material (e.g., the acoustic coupling body 328) may be disposed between the transmitter array 106 and the receiver array 302, as shown in the detail view 700-1, to provide a contiguous path through the acoustic coupling material for propagation of ultrasonic power. As described with reference to FIG. 2, FIG. 3, and FIG. 4, the acoustic coupling material may have an ultrasonic velocity that exceeds a threshold value (e.g., 1000 m/s, 1200 m/s, 1600 m/s, or 2400 m/s).

In implementations in which the acoustic coupling body 328 is not removed, the receiver array 302 can receive the ultrasonic confirmation pulse and the ultrasonic charging signal 110 via the contiguous path. In the over-the-air mode, the removable acoustic coupling material is removed. When the acoustic coupling material is removed, the power-transmitting subsystem 704 can transmit, and the power-receiving subsystem 706 can receive, the ultrasonic charging signal 110 across a gap between the transmitter array 106 and the receiver array 302. As noted (e.g., in FIG. 4 and the accompanying description), the acoustic coupling body 328 may include structural features (e.g., the mating nodes 404 in FIG. 4) that are shaped to interface with structural features of the electronic device 104 to provide a contiguous path for propagation of the ultrasonic charging signal 110. For example, truncated cones on the acoustic coupling body 328 can be mated to cavities with the same shape (e.g., the reception resonance cavities 308 in FIG. 4). Other shapes for the structural features may also be used, such as semi-spherical, pyramidal, or rectangular.

In some implementations, the wireless power-transmission system 702 may operate in both the contact mode and an over-the-air (non-contact) mode. For example, the electronic device 104-1 may be placed in contact with the wireless power-transmission system 702 at the same time the electronic device 104-4 may be placed next to the wireless power-transmission system 702. In such a case, the wireless power-transmission system 702 may operate in the contact mode to charge the electronic device 104-1 and in the over-the-air (non-contact) mode to charge the electronic device 104-4. In another case, the electronic device 104 may be placed in partial contact with the wireless power-transmission system 702. For example, the electronic device 104-1 may be placed on an edge so of the wireless power-transmission system 702 so that a gap exists or the wireless power-transmission system 702 may have debris on it, causing part of the electronic device 104-1 to be in contact with the wireless power-transmission system 702 and part of the electronic device 104-1 to be a distance away from the wireless power-transmission system 702. In this case, the wireless power-transmission system 702 may determine to operate some transmitters 108 in the contact mode and some transmitters 108 in the over-the-air mode.

Some implementations of the wireless power-transmission system 702 may include a voltage-tuning subsystem 712 and/or a frequency-tuning subsystem 714. The voltage-tuning subsystem 712 can determine that a particular receiver 304 of the receiver array 302 is transmitting an AC output voltage that is less than a threshold AC output voltage for the particular receiver 304 and increase the AC input voltage to the particular receiver 304 by a predefined amount (e.g., an amount between approximately 100 millivolts and approximately one volt (V), such as 500 millivolts). The voltage-tuning subsystem 712 can then determine that the increased AC input voltage corresponds to the DC voltage being closer to, or not closer to, a target DC voltage value (e.g., a voltage between approximately one V and approximately 9 V, such as 4.2 V or 5 V). In response to determining that the DC voltage is closer to the target DC voltage value, the voltage-tuning subsystem 712 can maintain the increased AC input voltage to the particular receiver 304. In cases in which the voltage-tuning subsystem 712 determines that the DC voltage is not closer to the target DC voltage value, the voltage-tuning subsystem 712 can reduce the AC input voltage to the particular receiver 304 by the predefined amount.

In some cases, the determination to maintain the increased AC input voltage may be based on whether the increased AC input voltage causes the overall power output of the receiver array 302 to increase. For example, the voltage-tuning subsystem 712 may determine to maintain the increased AC input voltage when the overall power output increase exceeds a threshold amount (e.g., a fixed threshold such as 50 milliwatts (mW) or 100 mW, or a variable threshold such as a percent (%) of a current overall power output such as 0.5%, 1%, or 2.5%).

The frequency-tuning subsystem 714 can determine that a particular receiver 304 of the receiver array 302 is transmitting an AC output voltage less than a threshold AC output voltage for the particular receiver 304 and increase a frequency of the AC input voltage to the particular receiver 304 by a predefined amount (e.g., an amount between approximately 200 kilohertz (KHz) and approximately 1.5 megahertz (MHz), such 1 MHz). The frequency-tuning subsystem 714 can then determine that the increased frequency of the AC input voltage corresponds to the DC voltage being closer to, or not closer to, a target DC voltage value (e.g., a voltage between approximately one V and approximately 9 V, such as 4.2 V or 5 V). In response to determining that the DC voltage is closer to the target DC voltage value, the frequency-tuning subsystem 714 can maintain the increased frequency of the AC input voltage to the particular receiver 304. In cases in which the frequency-tuning subsystem 714 determines that the DC voltage is not closer to the target DC voltage value, the frequency-tuning subsystem 714 can reduce the frequency of the AC input voltage to the particular receiver 304 by the predefined amount.

In some cases, the determination to maintain the increased frequency of the AC input voltage may be based on whether the increased frequency causes the overall power output of the receiver array 302 to increase. For example, the frequency-tuning subsystem 714 may determine to maintain the increased frequency when the overall power output increase exceeds a threshold amount (e.g., a fixed threshold such as 50 mW or 100 mW, or a variable threshold such as a percent (%) of a current overall power output such as 0.5%, 1%, or 2.5%).

In still other implementations, the wireless power-transmission system 702 may include a modulation subsystem (not shown in FIG. 7). The modulation subsystem can provide a power-adjusting modulation signal to the power-transmitting subsystem 704 that causes the power-transmitting subsystem 704 to request the input power amplifier to change the AC input voltage. The power-adjusting modulation signal can take various values. For example, in some implementations, the power-adjusting modulation signal may be one of a modulation of approximately 1.0 KHz that causes the power-transmitting subsystem 704 to request the input power amplifier to maintain the AC input voltage, a modulation of approximately 1.1 KHz that causes the power-transmitting subsystem to request the input power amplifier to increase the AC input voltage by a predefined amount, or a modulation of approximately 0.9 KHz that causes the power-transmitting subsystem to request the input power amplifier to decrease the AC input voltage by a predefined amount. The predefined amount may be a variety of values, for example, an amount between approximately 500 millivolts and approximately 5 volts, such as one volt. In other implementations, the power-adjusting modulation signal may be based on more-complex modulation schemes, such as Manchester encoding with a frequency-shift keying (FSK) physical transport layer.

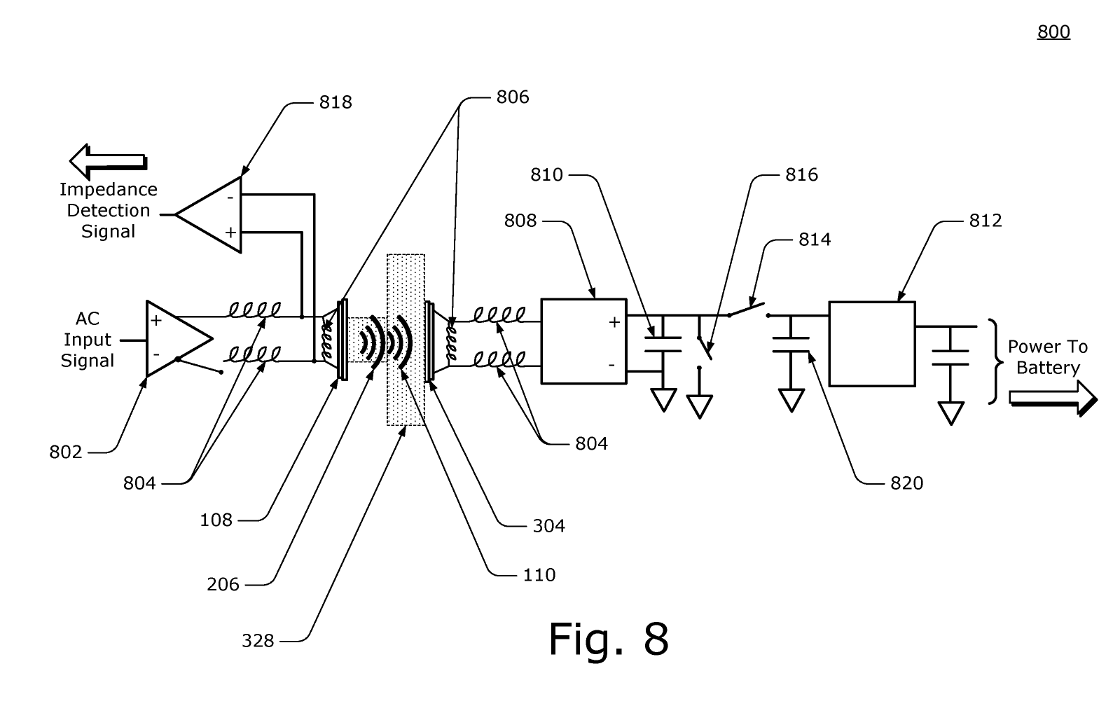

FIG. 8 illustrates generally at 800 an example of circuitry that can be used to implement ultrasonic power transmission with impedance detection. Specifically, an example of circuitry for the wireless power-transmission system 702 is shown (including the power-transmitting subsystem 704, the power-receiving subsystem 706, the acoustic-impedance detection subsystem 708 (e.g., the acoustic-impedance detection system 220), and the charging subsystem 710 (e.g., the charging system 326). In some implementations, the wireless power-transmission system 702 may also include either or both of the transmitter coupling material 206 and the acoustic coupling body 328. For clarity, only a single transmitter 108 of the transmitter array 106 and a single receiver 304 of the receiver array 302 are shown. As illustrated, example circuitry for the power-transmitting subsystem 704) includes an input power amplifier 802 and a transmitter 108. In some implementations, the power-transmitting subsystem 704 also includes tuning inductors 804 that are connected in series between the input power amplifier 802 and the transmitter 108, and a shunt inductor 806 that is connected in parallel to the transmitter 108.

The input power amplifier 802 amplifies an AC input signal at an ultrasonic frequency (e.g., between 500 KHz and 8 MHz, such as 2 MHz or 4 MHz) and transmits the AC input signal to the transmitter 108. The transmitter 108 can receive an AC input signal, convert the AC input voltage to an ultrasonic charging signal (e.g., the ultrasonic charging signal 110), and transmit the ultrasonic charging signal 110. In implementations that include the tuning inductors 804, the tuning inductors 804 allow the transmitter 108 to be tuned to resonance. The shunt inductor 806 may be used to aid with impedance modulation and signaling as described herein.

Example circuitry for the power-receiving subsystem 706, as illustrated, includes the receiver 304. In some implementations, the power-receiving subsystem 706 may also include the tuning inductors 804 (connected in series between the receiver 304 and the charging subsystem 710) and a shunt inductor 806 that is connected in parallel to the receiver 304. The receiver 304 can receive the ultrasonic charging signal 110, convert the ultrasonic charging signal 110 to an AC output signal, and transmit the AC output signal to the charging subsystem 710.

As shown in FIG. 8, example circuitry for the charging subsystem (e.g., the charging system 326) includes a rectifier 808, a smoothing capacitor 810 (e.g., a reservoir capacitor), and a DC-to-DC converter 812 (DC/DC converter 812). The rectifier 808 can be a variety of types of rectifier (e.g., a single-phase half-wave rectifier, a single-phase full-wave bridge rectifier, or a multi-phase rectifier) that can convert the AC output signal to a DC signal. Because the DC signal transmitted from the rectifier 808 is a pulsating signal, (e.g., has a high level of ripple), the smoothing capacitor 810 can be used to convert the pulsating signal to a continuous (smooth) output signal. Because the continuous output signal may still be a varying DC signal, the DC/DC converter 812 can be used to convert the varying DC signal to a particular steady voltage (e.g., 4.2 volts for charging a lithium-ion battery or 5 volts for input to a USB charging device).

Example circuitry for the acoustic-impedance detection subsystem 708 (e.g., acoustic-impedance detection system 220), as shown in FIG. 8, includes a series switch 814, a shunt switch 816, a signal-output amplifier 818, and a signal capacitor 820. During normal operation of the wireless power-transmission system 702, the series switch 814 is closed and the shunt switch 816 is open and power can be transmitted to, for example, a battery. Impedance modulation and signaling can performed by the series switch 814 and the shunt switch 816. When the series switch 814 is open, a low impedance is detected by the transmitter 108 (e.g., an impedance close to that of open air). When the shunt switch 816 is closed, the transmitter 108 detects an increased impedance (e.g., close to a short). In this way, a change in impedance can be caused by opening and closing the series switch 814 and the shunt switch 816.

For example, when the shunt switch 816 is closed, making a short, the receiver 304 effectively becomes stiffer and more difficult to deflect. In this case, when the transmitter 108 transmits an ultrasonic signal, there will be less deflection (compared to when the shunt switch 816 is open) and the impedance at the transmitter 108 changes. In response to the change in impedance, a voltage across the transmitter 108 also changes (so long as the AC input from the input power amplifier 802 remains constant). The signal-output amplifier 818 can detect the voltage change and transmit an impedance detection signal (e.g., the impedance modulation described with reference to FIG. 2, FIG. 3, and/or FIG. 7). During signaling, when the series switch 814 is open, the signal capacitor 820 on the DC/DC converter 812 can maintain the DC signal from the rectifier 808 so that the output voltage transmitted from the DC/DC converter 812 does not vary.

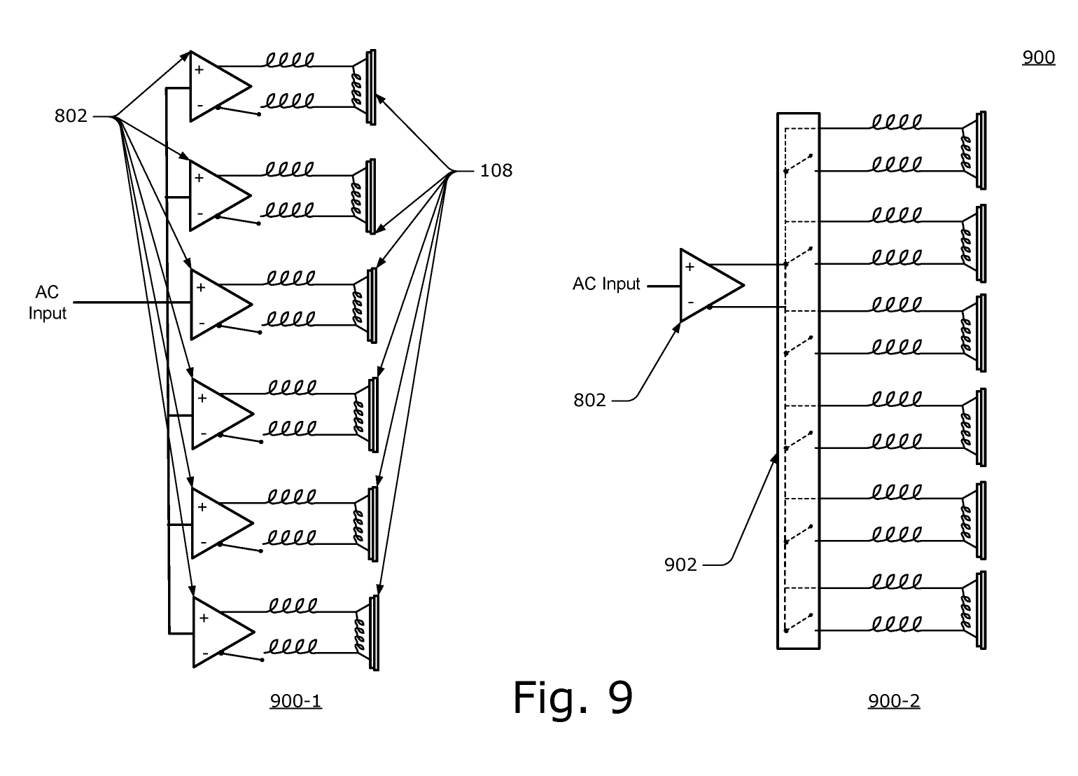

FIG. 9 illustrates additional details 900 of the example circuitry of FIG. 8. In some implementations, it may not be practical or economical to construct multiple instances of the example circuitry 800 for the transmitters 108 of the transmitter array 106 and the receivers 304 of the receiver array 302 (e.g., for a system having a transmitter array 106 and a receiver array 302 that both include a relatively large number of ultrasonic transducers, such as 64 ultrasonic transducers). In such implementations, a number of input power amplifiers 802 can be reduced by using a switch matrix to enable only the transmitters 108 that are determined to be proximate to an object (e.g., that are matched to a receiver 304), as described with reference to FIG. 2 and FIG. 7. A detail view 900-1 illustrates an example arrangement of a part of the transmitter array 106 with six transmitters 108. As shown in the detail view 900-1, the example arrangement also includes six input power amplifiers 802.

In contrast, another detail view 900-2 illustrates another example arrangement of a part of the transmitter array 106 that includes six transmitters 108 and a switch matrix 902. The switch matrix 902 can power multiple transmitters 108 with a single input power amplifier 802. As shown in the detail view 900-2, the switch matrix 902 can enable the input power amplifier 802 to power a number of the transmitters 108 independently.

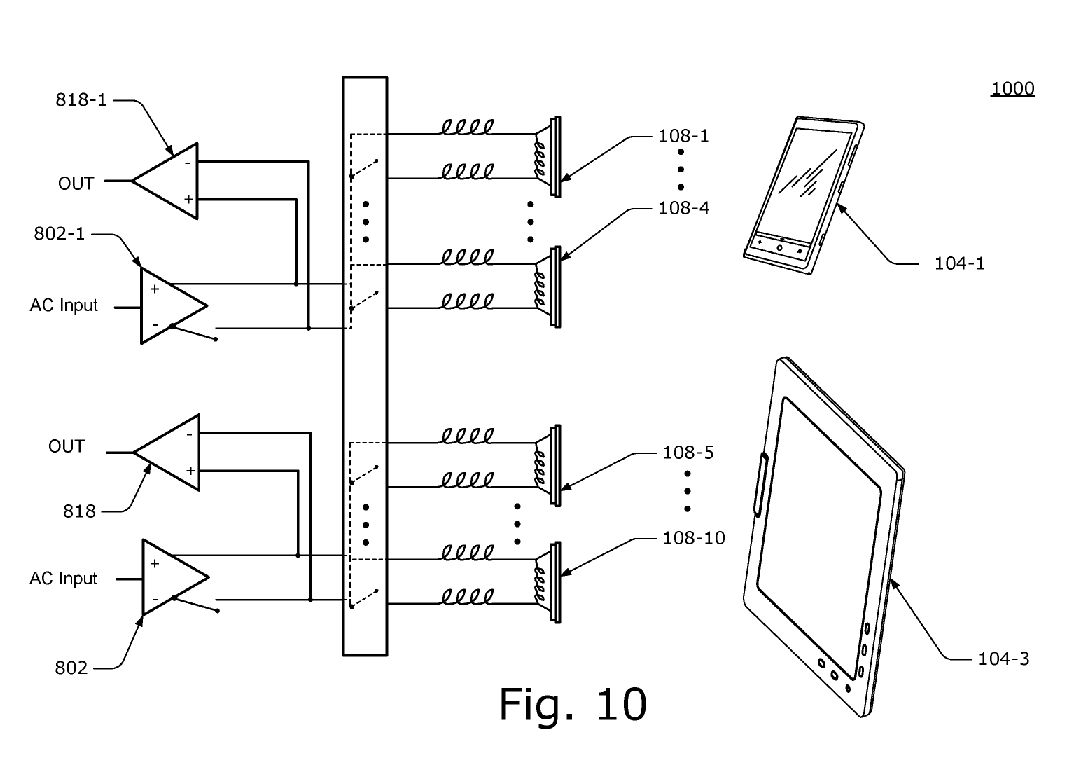

FIG. 10 illustrates additional details 1000 of the example circuitry of FIG. 8. In some implementations, the wireless power-transmission system 702 with ultrasonic power transmission with impedance detection can be used to provide power (e.g., via the ultrasonic charging signal 110) to multiple devices at one time, such as to the electronic devices 104-1 through 104-4. In the example implementation illustrated in FIG. 10, the transmitter array 106 includes multiple input power amplifiers 802 and multiple signal-output amplifiers 818. For example, the electronic device 104 may be aligned over four transmitters 108 (e.g., 108-1 through 108-4). One input power amplifier 802-1, along with one signal-output amplifier 818-1, can detect the electronic device 104-1 and provide power to the transmitters 108-1 through 108-4, as described with reference to FIG. 1 through FIG. 9). Similarly, the electronic device 104-3 may be aligned over six transmitters 108 (e.g., 108-5 through 108-10). Another input power amplifier 802-2, along with another signal-output amplifier 818-2, can detect the electronic device 104-3 and provide power to the transmitters 108-5 through 108-10.

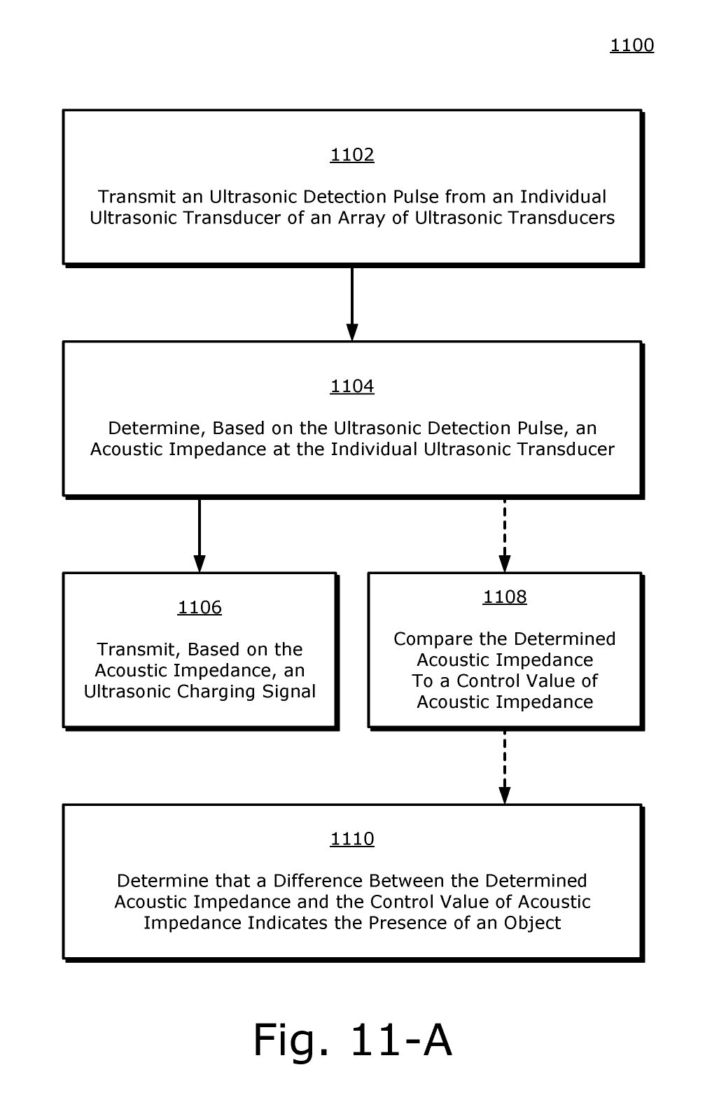

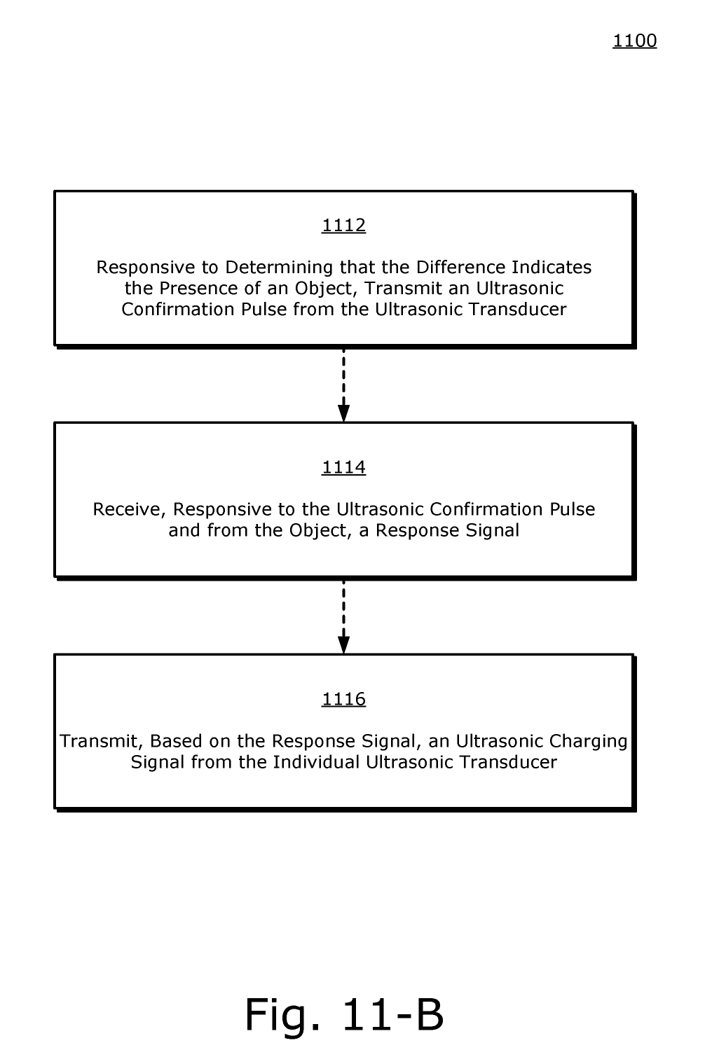

FIGS. 11-A and 11-B are a flow diagrams illustrating an example process 1100 for implementing ultrasonic power transmission with impedance detection. The process 1100 is described in the form of a set of blocks 1102-1116 that specify operations that can be performed.

At block 1102, at least one ultrasonic transducer of an array of ultrasonic transducers transmits an ultrasonic detection pulse. For example, the acoustic-impedance detection system 220 may transmit the ultrasonic detection pulse from the transmitter 108 of the transmitter array 106. The ultrasonic detection pulse can be an ultrasonic signal that has a duration that is less than a predefined duration (e.g., less than approximately 100 milliseconds or less than approximately 200 milliseconds).

In some implementations, the acoustic-impedance detection system 220 may transmit the ultrasonic detection pulse from the from respective ultrasonic transducers of the array of ultrasonic transducer one at a time (e.g., in sequence). In other implementations, the acoustic-impedance detection system 220 may transmit the ultrasonic detection pulse from the entire transmitter array all at once (e.g., the individual ultrasonic transducers transmit the ultrasonic detection pulse approximately simultaneously).

Additionally or alternatively, the acoustic-impedance detection system 220 may transmit the ultrasonic detection pulse periodically. The period may be an approximately regular interval (e.g., five seconds, 30 seconds, or two minutes) or the period may be event-based, such as at start up or after a power outage.

At block 1104, an acoustic impedance at the one ultrasonic transducer is determined, based on a response to the ultrasonic detection pulse. For example, the acoustic-impedance detection system 220 may determine the acoustic impedance at the transmitter 108 (e.g., as described with reference to FIG. 8).

At block 1106, based on the determined acoustic impedance, an ultrasonic charging signal is transmitted from the one ultrasonic transducer (or from another ultrasonic transducer of the array). For example, the acoustic-impedance detection system 220 can transmit an ultrasonic charging signal (e.g., the ultrasonic charging signal 110) from the transmitter 108 to the electronic device 104.

Additionally or alternatively, transmitting the ultrasonic charging signal may be based on a determination of a response signal, as described with respect to blocks 1108-1116. For example, at block 1108, the determined acoustic impedance (e.g., from block 1104) is compared to a control value of acoustic impedance. For example, the acoustic-impedance detection system 220 may compare the determined acoustic impedance to an acoustic impedance of air at ambient conditions.

At block 1110, it is determined that a difference between the determined acoustic impedance and the control value of acoustic impedance indicates a presence of an object. For example, in implementations in which the control value of acoustic impedance is that of air, the acoustic-impedance detection system 220 can compare the determined value of acoustic impedance at one or more of the transmitters 108 with the control value of acoustic impedance. When the determined value is different from the control value, the difference may indicate that something other than air (e.g., the electronic device 104) is present near the array 106 or the particular transmitter 108 that is performing the determination.

At block 1112, responsive to determining that the difference indicates the presence of the object, an ultrasonic confirmation pulse is transmitted from the one ultrasonic transducer (or from another ultrasonic transducer of the array). For example, the ultrasonic confirmation pulse may be an ultrasonic signal of a longer duration than the ultrasonic detection pulse and/or of a higher power level.

At block 1114, in response to the ultrasonic confirmation pulse, a response signal is received from the object. For example, the response signal may be received from the electronic device 104. In some implementations, the response signal may be a modulation of the acoustic impedance, and receiving the response signal may include detecting the modulation of the acoustic impedance.

At block 1116, based on the response signal, the ultrasonic charging signal is transmitted from the one ultrasonic transducer (or from another ultrasonic transducer of the array). For example, the acoustic-impedance detection system 220 can transmit the ultrasonic charging signal (e.g., the ultrasonic charging signal 110) from the transmitter 108 to the electronic device 104. The transmitting , based on the response signal, of the ultrasonic charging signal may be alternative to, or in addition to, the transmitting of the ultrasonic charging signal as described with respect to block 1106. As with the ultrasonic detection pulse, the ultrasonic confirmation pulse may be transmitted from individual transmitters 108 one at a time or from the array 106 all at once.

In some cases, a removable acoustic coupling material is disposed between the array of ultrasonic transducers and the object so as to be in contact with both the array of ultrasonic transducers and the object (e.g., the acoustic coupling body 328 may be disposed between the ultrasonic power-transmission device 102 and the electronic device 104). In this case, transmitting the ultrasonic detection pulse, the ultrasonic confirmation pulse, and the ultrasonic charging signal is performed by propagating the ultrasonic detection pulse, the ultrasonic confirmation pulse, and the ultrasonic charging signal, respectively, through the removable acoustic coupling material. In other cases, the removable acoustic coupling material is removed. In the other cases, transmitting the ultrasonic detection pulse, the ultrasonic confirmation pulse, and the ultrasonic charging signal is performed by propagating the ultrasonic detection pulse, the ultrasonic confirmation pulse, and the ultrasonic charging signal, respectively, across a gap between the array of ultrasonic transducers and the object.

As noted, the process 1100 is described in the form of a set of blocks 1102-1116 that specify operations that can be performed. However, the operations are not necessarily limited to the order shown in FIG. 11-A, FIG. 11-B, or as described herein. Rather, the operations may be implemented in alternative orders or in fully or partially overlapping manners. Operations represented by the illustrated blocks of the process 1100 may be performed, for example, by the wireless power-transmission system 702 and/or by various combinations of the components, systems, and subsystems described with reference to FIG. 1 through FIG. 10.

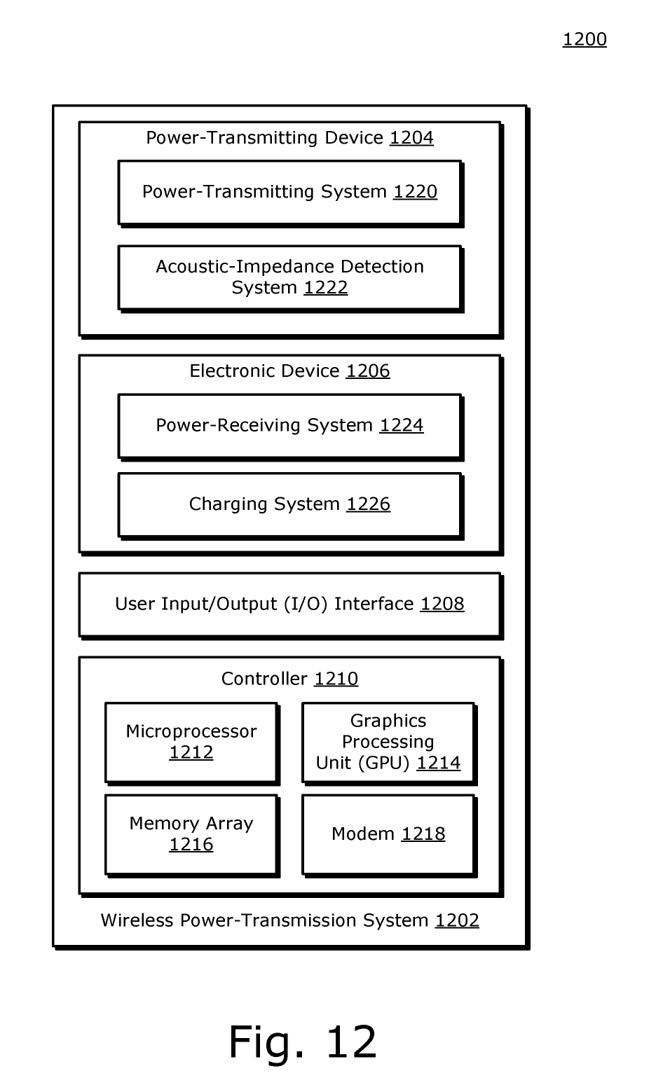

FIG. 12 illustrates generally at 1200 an example wireless power-transmission system 1202 that can be used to implement ultrasonic power transmission with impedance detection. As shown, the wireless power-transmission system 1202 includes a power-transmitting device 1204, an electronic device 1206, a user input/output (I/O) interface 1208, and a controller 1210. Illustrated examples of the controller 1210 include a microprocessor 1212, a graphics processing unit (GPU) 1214, a memory array 1216, and a modem 1218. In one or more example implementations, a power-transmitting system 1220, and/or an acoustic-impedance detection system 1222, as described herein can be implemented in the power-transmitting device 1204. For example, the power-transmitting system 1220 may correspond to the power-transmitting subsystem 704. Similarly, the acoustic-impedance detection system 1222 may correspond to the acoustic-impedance detection system 220. Additionally, a power-receiving system 1224, and/or a charging system 1226, as described herein can be implemented in the electronic device 1206. For example, the power-receiving system 1224 may correspond to the power-receiving subsystem 706. Similarly, the charging system 1226 may correspond to the charging system 326. Thus, the wireless power-transmission system 1202 can enable wireless charging of battery-powered devices, using an ultrasonic charging signal with improved efficiency as compared to existing approaches and with a reduced risk of EM interference.

The power-transmitting device 1204 can be a mobile or battery-powered device or a fixed device that is designed to be powered by an electrical grid. Examples of the power-transmitting device 1204 include a desktop charging pad, a contoured or shaped charging receptacle (e.g., a receptacle designed to receive a camera or an audio speaker), a pedestal charging stand, or a flexible charging mat). The electronic device 1206 can be a mobile or battery-powered device. Examples of the electronic device 1206 include a server computer, a network switch or router, a blade of a data center, a personal computer, a desktop computer, a notebook or laptop computer, a tablet computer, a smart phone, an entertainment appliance, a display device such as a television or monitor, or a wearable computing device such as a smartwatch, intelligent glasses, or an article of clothing. The electronic device 1206 can also be a device, or a portion thereof, having embedded electronics. Examples of the electronic device 1206 with embedded electronics include a drone (or other unmanned aerial vehicle), or a power tool.

The wireless power-transmission system 1202 as shown also includes at least one user I/O interface 1208. Examples of the user I/O interface 1208 include a keyboard, a mouse, a microphone, a touch-sensitive screen, a camera, an accelerometer, a haptic mechanism, a speaker, a display screen, or a projector. The user I/O interface 1208 can correspond to, for example, a user interface of ultrasonic power-transmission device 102 or a user interface of the electronic device 104.

In some implementations, the controller 1210 may be coupled to one or both of the power-transmitting device 1204 or the electronic device 1206. For example, the controller 1210 may be integrated with the power-transmitting device 1204 or the electronic device 1206. In other implementations, the controller 1210 may be separate from the power-transmitting device 1204 and the electronic device 1206 and communicatively coupled via a communication system (e.g., the modem 1218, or another network connection). The controller 1210 may comprise, for example, one or more instances of a microprocessor 1212, a GPU 1214, a memory array 1216, a modem 1218, and so forth. Alternatively or additionally, the controller 1210 can correspond to, for example, the processor 208 and/or the processor 310 (e.g., of FIG. 2 and FIG. 3, respectively).

The microprocessor 1212 may function as a central processing unit (CPU) or other general-purpose processor. Some microprocessors include different parts, such as multiple processing cores, that may be individually powered on or off. The GPU 1214 may be especially adapted to process visual-related data for display, such as video data images. If visual-related data is not being rendered or otherwise processed, the GPU 1214 may be fully or partially powered down. The memory array 1216 stores data for the microprocessor 1212 or the GPU 1214. Example types of memory for the memory array 1216 include random access memory (RAM), such as dynamic RAM (DRAM) or static RAM (SRAM); flash memory; and so forth. If programs are not accessing data stored in memory, the memory array 1216 may be powered down overall or block-by-block. The modem 1218 demodulates a signal to extract encoded information or modulates a signal to encode information into the signal. If there is no information to decode from an inbound communication or to encode for an outbound communication, the modem 1218 may be idled to reduce power consumption. The controller 1210 may include additional or alternative parts than those that are shown, such as an I/O interface, a sensor such as an accelerometer, a transceiver or another part of a receiver chain, a customized or hard-coded processor such as an application-specific integrated circuit (ASIC), and so forth.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An apparatus for charging a battery in an electronic device, comprising:
an array of ultrasonic transducers; and
an acoustic-impedance detection system configured to:
transmit an ultrasonic detection pulse from an ultrasonic transducer of the array of ultrasonic transducers;
determine, based on a response to the ultrasonic detection pulse, an acoustic impedance at the ultrasonic transducer; and
transmit, based on the acoustic impedance, an ultrasonic charging signal.

2. The apparatus of claim 1, wherein the acoustic-impedance detection system is further configured to:
compare the determined acoustic impedance to a control value of acoustic impedance;
determine that a difference between the determined acoustic impedance and the control value of acoustic impedance indicates a presence of an object;
responsive to determining that the difference indicates the presence of the object, transmit an ultrasonic confirmation pulse;
receive, responsive to the ultrasonic confirmation pulse and from the electronic device, a response signal; and
transmit, based on the response signal, the ultrasonic charging signal.

3. The apparatus of claim 2, wherein the response signal comprises a modulation of the acoustic impedance at the ultrasonic transducer, and the acoustic-impedance detection system is further configured to detect the modulation of the acoustic impedance at the ultrasonic transducer.

4. The apparatus of claim 2, wherein:
the ultrasonic confirmation pulse is transmitted from an ultrasonic transducer of the array of ultrasonic transducers that is different from the ultrasonic transducer that transmits the ultrasonic detection pulse; and
the ultrasonic charging signal is transmitted from an ultrasonic transducer of the array of ultrasonic transducers that is different from the ultrasonic transducer that transmits the ultrasonic detection pulse.

5. The apparatus of claim 1, further comprising:
a housing, the housing including transmission resonance cavities disposed in a surface of the housing, the transmission resonance cavities adjacent to the ultrasonic transducers of the array and configured such that an amount of power transmitted by the ultrasonic transducers is increased via resonance in the transmission resonance cavities; and
a transmitter coupling material, the transmitter coupling material adjacent to the array of ultrasonic transducers and disposed such that the ultrasonic charging signal propagates through the transmitter coupling material.

6. The apparatus of claim 5, wherein the array of ultrasonic transducers is configured such that the ultrasonic charging signal propagates through the transmitter coupling material and through a removable coupling material, the removable coupling material:
being disposed between the array of ultrasonic transducers and the electronic device; and
being in contact with the transmitter coupling material and with the electronic device, so as to provide a contiguous path for propagation of the ultrasonic charging signal.

7. The apparatus of claim 6, wherein the removable coupling material has an ultrasonic velocity greater than 1000 meters per second.

8. The apparatus of claim 6, wherein the array of ultrasonic transducers is configured to transmit the ultrasonic charging signal across a gap between the array of ultrasonic transducers and the electronic device when the removable coupling material is removed.

9. The apparatus of claim 1, wherein:
the ultrasonic transducers of the array of ultrasonic transducers have a thickness measured in a dimension that is approximately parallel to a direction in which the ultrasonic charging signal propagates and a width that is approximately perpendicular to the thickness, the thickness being greater than the width;
the width is less than a wavelength of the ultrasonic charging signal;
the thickness is related to the wavelength of the ultrasonic charging signal so as to cause the ultrasonic transducers to operate as resonant transducers;
the array of ultrasonic transducers is configured in a shape that is one of rectangular, hexagonal, or pentagonal; and
the array of ultrasonic transducers is arranged such that a distance between particular ultrasonic transducers of the array is less than the wavelength of the ultrasonic charging signal.

10. A method for detecting an electronic device with acoustic impedance, comprising:
transmitting an ultrasonic detection pulse from at least one ultrasonic transducer of an array of ultrasonic transducers;
determining, based on a response to the ultrasonic detection pulse, an acoustic impedance at the one ultrasonic transducer; and
transmitting, based on the acoustic impedance, an ultrasonic charging signal from the one ultrasonic transducer or from another one of the ultrasonic transducers of the array.

11. The method of claim 10, further comprising:
comparing the determined acoustic impedance to a control value of acoustic impedance;
determining that a difference between the determined acoustic impedance and the control value of acoustic impedance indicates a presence of an object;
responsive to determining that the difference indicates the presence of the object, transmitting an ultrasonic confirmation pulse from the one ultrasonic transducer or from another one of the ultrasonic transducers of the array; and
receiving, responsive to the ultrasonic confirmation pulse and from the object, a response signal,
wherein the transmitting of the ultrasonic charging signal from the one ultrasonic transducer or from another one of the ultrasonic transducers of the array is further based on the response signal.

12. The method of claim 11, wherein a removable acoustic coupling material is disposed between the array of ultrasonic transducers and the object so as to be in contact with both the array of ultrasonic transducers and the object, and wherein:
transmitting the ultrasonic detection pulse further comprises propagating the ultrasonic detection pulse through the removable acoustic coupling material;
transmitting the ultrasonic confirmation pulse further comprises propagating the ultrasonic confirmation pulse through the removable acoustic coupling material; and
transmitting the ultrasonic charging signal further comprises propagating the ultrasonic charging signal through the removable acoustic coupling material.

13. The method of claim 11, wherein:
transmitting the ultrasonic detection pulse further comprises propagating the ultrasonic detection pulse across a gap between the array of ultrasonic transducers and the object;
transmitting the ultrasonic confirmation pulse further comprises propagating the ultrasonic confirmation pulse across the gap between the array of ultrasonic transducers and the object; and
transmitting the ultrasonic charging signal further comprises propagating the ultrasonic charging signal across the gap between the array of ultrasonic transducers and the object.

14. The method of claim 11, further comprising performing operations of the method by multiple transducers of the array of ultrasonic transducers, and wherein a particular operation is performed by the entirety of the multiple transducers approximately simultaneously, or by respective transducers in sequence, one at a time.

15. The method of claim 10, wherein transmitting the ultrasonic detection pulse from the one ultrasonic transducer of the array of ultrasonic transducers further comprises transmitting the ultrasonic detection pulse periodically.

16. An apparatus for acoustic power transfer, comprising:
an array of ultrasonic transducers configured to:
receive an ultrasonic confirmation pulse from an ultrasonic charging device;
receive an ultrasonic charging signal from the ultrasonic charging device;
convert the ultrasonic charging signal to an AC output voltage; and
transmit the AC output voltage;
an acoustic-impedance feedback system, communicatively coupled with the array of ultrasonic transducers and configured to:
determine that the ultrasonic confirmation pulse at a particular ultrasonic transducer of the array has a power level or a duration that exceeds a threshold value; and
responsive to determining that the power level or the duration of the ultrasonic confirmation pulse at the particular ultrasonic transducer exceeds the threshold value, cause the particular ultrasonic transducer to initiate a modulation of an acoustic impedance of the particular ultrasonic transducer, the modulation detectable by the ultrasonic charging device; and
a charging system, communicatively coupled with the array of ultrasonic transducers and configured to charge a load of the apparatus, based on the AC output voltage.

17. The apparatus of claim 16, wherein charging the load of the apparatus comprises converting the AC output voltage to a DC voltage and transmitting the DC voltage to the load.

18. The apparatus of claim 16, further comprising a voltage-tuning subsystem configured to:
determine that a particular ultrasonic transducer of the array of ultrasonic transducers is transmitting the AC output voltage at less than a threshold AC output voltage for the particular ultrasonic transducer;
increase an input voltage to the particular ultrasonic transducer by a predefined amount;
determine that the increased input voltage corresponds to the AC output voltage being closer to, or not closer to, the threshold AC output voltage; and
responsive to the determining that the AC output voltage is closer to the threshold AC output voltage, maintain the increased input voltage to the particular ultrasonic transducer; or
responsive to the determining that the AC output voltage is not closer to the threshold AC output voltage, reduce the increased input voltage to the particular ultrasonic transducer by the predefined amount.

19. The apparatus of claim 16, further comprising a frequency-tuning subsystem configured to:
determine that a particular ultrasonic transducer of the array of ultrasonic transducers is transmitting the AC output voltage at less than a threshold AC output voltage for the particular ultrasonic transducer;
increase a frequency of an input voltage to the particular ultrasonic transducer by a predefined amount;
determine that the increased frequency of the input voltage corresponds to the AC output voltage being closer to, or not closer to, the threshold AC output voltage; and
responsive to the determining that the AC output voltage is closer to the threshold AC output voltage, maintain the increased frequency of the input voltage to the particular ultrasonic transducer; or
responsive to the determining that the AC output voltage is not closer to the threshold AC output voltage, reduce the increased frequency of the increased input voltage to the particular ultrasonic transducer by the predefined amount.

20. The apparatus of claim 19, wherein the predefined amount is between approximately 200 kilohertz (KHz) and approximately 1.5 megahertz.

21. The apparatus of claim 16, further comprising a modulation subsystem that is configured to provide a power-adjusting modulation signal to the ultrasonic charging device that causes the ultrasonic charging device to change an AC input voltage, the power-adjusting modulation signal comprising:
a modulation at a first frequency that causes the ultrasonic charging device to maintain the AC input voltage;
a modulation at a second frequency, different from the first frequency, that causes the ultrasonic charging device to increase the AC input voltage by a predefined amount; or
a modulation at a third frequency, different from the first frequency and the second frequency, that causes the ultrasonic charging device to decrease the AC input voltage by another predefined amount.

22. The apparatus of claim 16, further comprising a removable acoustic coupling body disposed between the array of ultrasonic transducers and the ultrasonic charging device, the removable acoustic coupling body made from a material having an ultrasonic velocity greater than 1000 meters per second.

23. The apparatus of claim 22 wherein the removable acoustic coupling body is made from one of:
an aluminum alloy;
a copper alloy;
a titanium alloy;
a polystyrene;
a butyl rubber;
a polyamide;
a polyethylene; or
a melamine.

24. The apparatus of claim 22, wherein the array of ultrasonic transducers is configured to:
receive the ultrasonic signal through the removable acoustic coupling body when the removable acoustic coupling body is disposed between the array of ultrasonic transducers and the ultrasonic charging device; and
receive the ultrasonic signal across a gap between the array of ultrasonic transducers and the ultrasonic charging device when the removable acoustic coupling body is removed.

25. The apparatus of claim 16, further comprising a device case that includes reception resonance cavities, corresponding to the ultrasonic transducers of the array and disposed in a surface of the device case, the reception resonance cavities adjacent to the ultrasonic transducers of the array and configured such that an amount of power received by the ultrasonic transducers of the array is increased via resonance in the reception resonance cavities.
